(19) United States
(12) Patent Application Publication
(10) Pub. No.: US 2019/0301523 A1
(43) Pub. Date: Oct. 3, 2019

(54) BEARING DESIGN WITH COMBINED ROLLING ELEMENT MATERIAL

(71) Applicant: Schaeffler Technologies AG & Co. KG, Herzogenaurach (DE)

(72) Inventor: Scott HART, Sharon, SC (US)

(73) Assignee: Schaeffler Technologies AG & Co. KG, Herzogenaurach (DE)

(21) Appl. No.: 15/944,531

(22) Filed: Apr. 3, 2018

(51) Int. Cl. F16C 19/08; F16C 19/18; F16C 33/37; F16C 33/32; F16C 19/54

(52) U.S. Cl. CPC F16C 19/08; F16C 19/185; F16C 33/3713; F16C 2352/00; F16C 19/543; F16C 2240/70; F16C 33/32

(57) ABSTRACT

A bearing assembly, for example a thrust bearing assembly including first and second rings is provided with alternating high and low modulus rolling elements. The low modulus rolling elements have a greater diameter than the high modulus rolling elements so as to initially bear a relatively greater percentage of applied loads.

### FIELD OF INVENTION

The present invention relates to a bearing arrangement, and more particularly to rolling elements for thrust bearings with rolling elements of two materials arranged in an alternating sequence to maximize useful life of the bearing.

### BACKGROUND

Thrust roller bearing arrangements are known for a variety of machine design applications. Bearings for down hole drill motors undergo high-force impacts and are lubricated with drilling mud typically composed of a water-based clay mixture. As such, down hole drill motor bearings generally have a short life in both the rings and the rolling element set. Steel rolling element failure modes include wear, spalling, and fracture.

The rolling elements typically fail before the rings and may be replaced multiple times while the rings are reused. Such instances halt work of the drill, increasing costs. Material choices among the various bearing parts contribute to different failure modes. For example, bearings with only ceramic rolling elements experience excessive wear of the rolling elements. Bearings with only steel rolling elements experience both excessive wear as well as fatigue.

Bearings with alternating smaller steel rolling elements interspersed between larger ceramic rolling elements have been proposed in U.S. Pat. No. 7,008,113 to extend the life of the rolling element set. However, it was found in actual use that this arrangement promotes fatigue in the bearing rings. Specifically, with fewer rolling elements contacting the rings (i.e., only the spaced-apart ceramic rolling elements), the stresses on the rings are increased exponentially. Moreover, the smaller steel rolling elements in such bearings are designed to not contact the ring sets in a manner that contributes to the overall ring set load-bearing capacity, and therefore their modulus of elasticity is not a design consideration.

It would be desirable to provide a thrust bearing assembly that better distributes applied loads across all bearing elements. It would further be desirable to maximize the useful life of the components, thereby improving efficiency and lowering costs.

### SUMMARY

Briefly stated, a bearing assembly is provided. The bearing assembly includes a first ring, a second ring, a plurality of high modulus rolling elements, and a plurality of low modulus rolling elements. The first ring has a first raceway. The second ring has a second raceway, and a ball track is defined between the raceways. The plurality of high modulus rolling elements have a first diameter and are disposed in the ball track. The plurality of low modulus rolling elements have a second diameter and are disposed in the ball track in an alternating relationship with the high modulus rolling elements. The second diameter is greater than the first diameter. A ratio of the first diameter to the second diameter is configured to distribute an externally applied load to both the high modulus rolling elements and the low modulus rolling elements. The ratio is also configured to initially distribute more of the externally applied load to the low modulus rolling elements. The ratio is also configured to, after usage of the bearing assembly and wear of the low modulus rolling elements, distribute the load more evenly between the high modulus rolling elements and the low modulus rolling elements.

### BRIEF DESCRIPTION OF THE DRAWINGS

The foregoing Summary and the following detailed description will be better understood when read in conjunction with the appended drawings, which illustrate a preferred embodiment of the invention. In the drawings:

FIG. 1 is side elevation view of a down hole drill having a thrust bearing assembly;

FIG. 2 is a side elevation view of a bearing assembly of the down hole drill of FIG. 1;

FIG. 3 is a graph of load percentage experienced by particular low modulus rolling elements as a function of size;

FIG. 4 is cross-sectional side view of the down hole drill of FIG. 1; and

FIG. 5 is a graph of load percentage experienced across a stack bearing.

### DETAILED DESCRIPTION

At the outset, it should be appreciated that like drawing numbers appearing in different drawing views identify identical, or functionally similar, structural elements. Furthermore, it is understood that this invention is not limited only to the particular embodiments, methodology, materials and modifications described herein, and as such may, of course, vary. It is also understood that the terminology used herein is for the purpose of describing particular aspects only, and is not intended to limit the scope of the present invention, which is limited only by the appended claims.

Unless defined otherwise, all technical and scientific terms used herein have the same meaning as commonly understood to one of ordinary skill in the art to which this invention belongs. Although any methods, devices or materials similar or equivalent to those described herein can be used in the practice or testing of the invention, the following example methods, devices, and materials are now described.

As used herein, the term “alternating” applies to both even-numbered and odd-numbered arrangements of bearing elements. As such, in an odd-numbered “alternating” arrangement of bearing elements, there is one sequential pair of the same material bearing element. For example, in a bearing arrangement with fifteen bearing elements, an “alternating” arrangement includes eight bearing elements of a first material and seven bearing elements of a second material, with two of the first material bearing elements sequentially next to each other.

Certain terminology is used in the following description for convenience only and is not limiting. “Ceramic” as a rolling element material may include rolling elements formed substantially from ceramic or formed of a different base material that is coated in ceramic. The words “front,” “rear,” “upper” and “lower” designate directions in the drawings to which reference is made. The words “radially inwardly” and “radially outwardly” refer to directions radially toward and away from an axis of the part being referenced. “Axially” refers to a direction along the axis of a shaft or other part. A reference to a list of items that are cited as “at least one of a, b, or c” (where a, b, and c represent the items being listed) means any single one of the items a, b, or c, or combinations thereof. The terminology includes the words specifically noted above, derivatives thereof and words of similar import.

The present disclosure relates to a bearing assembly for thrust applications of, e.g., a down hole drill. The bearing assembly includes first and second rings having respective first and second raceways, a plurality of high modulus bearings, and a plurality of low modulus bearings arranged in an alternating relationship with the high modulus bearings. The low modulus bearings have a diameter greater than the high modulus bearings to initially bear a majority of an externally applied load, resulting in an overall improved useful life of the whole assembly.

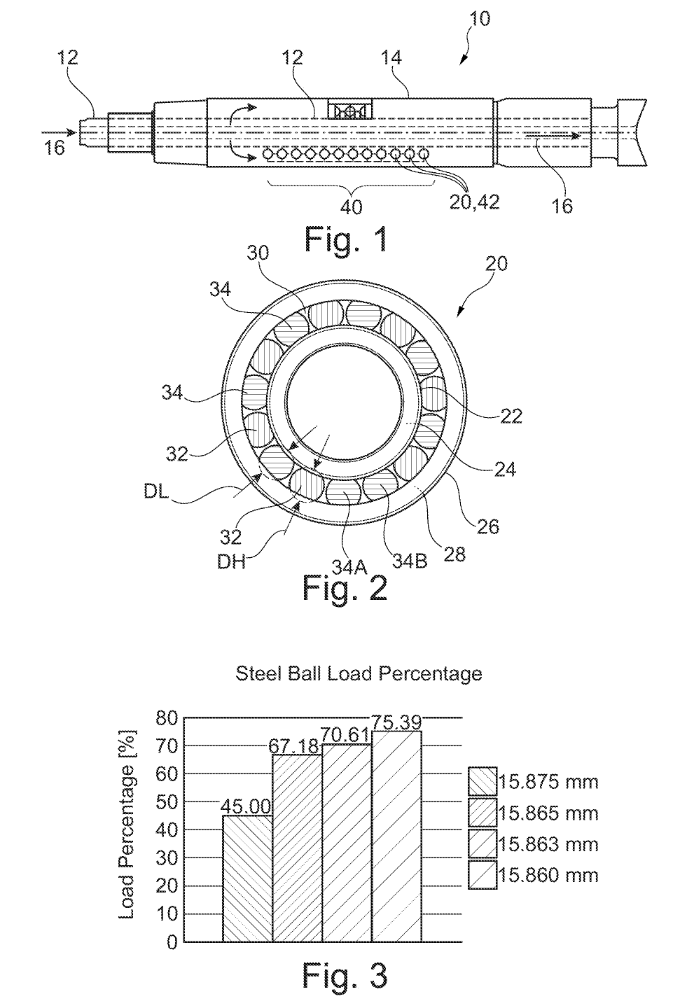

Referring to FIG. 1, a down hole drill 10 is shown with a drive shaft 12 and non-rotating housing 14. The drill 10 includes a plurality of bearing assemblies 20 as shown. Down hole drills 10 are generally known in the art. During use, a liquid passes through the drive shaft 12 and the bearing assemblies as indicated by arrows 16 for purposes of lubrication, cooling, and flushing.

As shown in FIG. 2, each bearing assembly 20 includes a first or inner ring 22 with a first raceway 24, a second or outer ring 26 with a second raceway 28, and a ball track 30 defined between the first and second raceways 24, 28. In an exemplary embodiment, the first and second rings 22, 26 are formed of a steel or steel alloy.

The bearing assembly 20 is provided with a first plurality of rolling elements 32 having relatively high modulus of elasticity, preferably formed of ceramic, which are also referred to as a plurality of high modulus rolling elements. The bearing assembly 20 is also provided with a second plurality of rolling elements 34 having a relatively low modulus of elasticity, preferably formed of steel, which is also referred to as a plurality of low modulus rolling elements. The high modulus rolling elements 32 and the low modulus rolling elements 34 are disposed in an alternating relationship such that no two high modulus rolling elements contact each other.

The high modulus rolling elements 32 have a diameter DH that is smaller than a diameter DL of the low modulus rolling elements 34. The ratio of DH to DL is designed to promote load distribution to the low modulus rolling elements 34, particularly during initial usage and before wear occurs. Due to the high applied loads, some elastic compression of the low modulus rolling elements 34 may occur during usage, increasing the load experienced by the high modulus rolling elements 32. Subsequently, after usage of the bearing assembly 20 resulting in wear of the low modulus rolling elements 34, loads applied to the bearing assembly will be more evenly distributed between the high modulus rolling elements 32 and the low modulus rolling elements 34.

As the low modulus rolling elements 34 wear, the high modulus rolling elements 32 will take on a relatively higher percentage of applied loads. For example, the high modulus rolling elements 32 may initially receive about 20% to about 40% of an applied load, and after usage progress to about 40%, about 50%, or about 60% of the same applied load. In some embodiments, an initial load percentage for the low modulus rolling elements 34 may be about 60% to about 80% of an externally applied load, preferably about 70%.

In one exemplary embodiment of a bearing assembly 20, seven high modulus rolling elements 32 are formed of a ceramic (silicon nitride Si₃N₄) with a modulus of elasticity of about 315 GPa and eight low modulus rolling elements 34 are formed of a steel (S2 tool steel) with a modulus of elasticity of about 210 GPa. DL is set at 15.875 mm, and DH is configured to share a predetermined load percentage. As shown in FIG. 3, to achieve a load percentage of about 70% in the low modulus rolling elements 34, DH is 15.863 mm.

For other embodiments, the low modulus rolling elements 34 may have a diameter DL that is about 8 to about 20 microns greater than DH. DH may be 17.462 mm in such embodiments. It is contemplated that a DL of up to about 50 microns greater than DH may be desirable in certain applications. The design of this difference between DH and DL is also affected by the contact angle between the raceways 24 and/or 28 and the rolling elements 32 and/or 34. Similarly the diameters of the inner and outer rings 22, 26 affect the design of the rolling elements 32, 34.

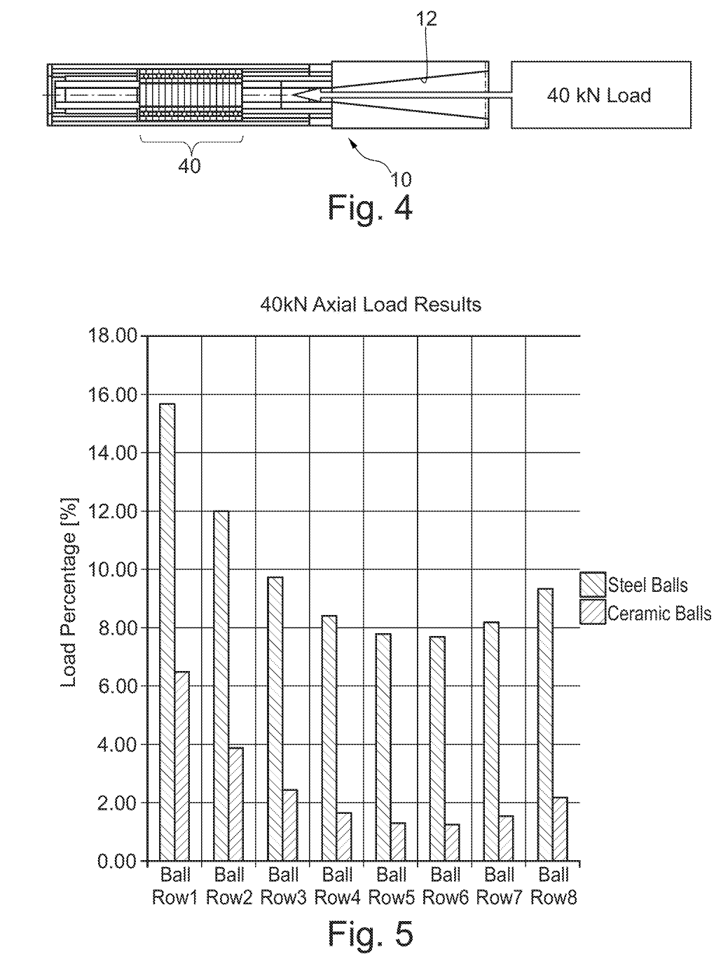

FIGS. 1 and 4 show that the bearing assembly 20 may be part of a stack bearing 40, that is, a plurality of bearing assemblies 20 arranged axially as a series of rows 42, as part of a down hole drill 10. A load is applied to the stack bearing 40 as indicated in FIG. 4, for example 40 kN. As shown in FIG. 5, when a 40 kN axial load is applied to the stack bearing, the load is distributed among the high modulus rolling elements 32 and low modulus rolling elements 34 in every row. Consequently, bearing assemblies 20 in different rows may be configured with different diameter ratios to account for the loads experienced by a particular row 42, so as to maximize the useful life of each row and the stack bearing 40 as a whole. Indeed, the bearing assembly 20 of each row 42 may have a unique DH and DL as compared to other rows, a unique DH with a constant DL, or a constant DH with a unique DL.

One skilled in the art should appreciate that the various ratios and dimensions discussed above may vary depending on the application, material choice, and the like. In some preferred embodiments, the ratio of DH to DL is about 99.80% to 99.50%.

The disclosed bearing assembly 20 provides a structure that extends the life of both the rolling elements 32, 34 and the rings 22, 26. The low modulus rolling elements 34 contribute not only to spacing apart the high modulus elements 32 from each other, but also contribute to sharing the applied loads across the whole bearing assembly 20. At the same time, the dimensions of the low modulus rolling elements 34 are configured to anticipate and account for the faster wear rate of the low modulus rolling elements relative to the high modulus rolling elements 32.

One skilled in the art would appreciate that the test results shown in FIGS. 3 and 5 are not merely correlations of size to performance, but instead are the result of a combination of variables. Moreover, it is counterintuitive in the art to design a bearing assembly 10 wherein the stronger rolling element (i.e., high modulus rolling element 32) does not bear the majority of the applied loads (at least initially). Likewise it would be unexpected for a bearing assembly 10 to exhibit a longer useful life while the weaker rolling elements (low modulus rolling elements 34) bear the majority of the applied loads.

Having thus described the present invention in detail, it is to be appreciated and will be apparent to those skilled in the art that many physical changes, only a few of which are exemplified in the detailed description of the invention, could be made without altering the inventive concepts and principles embodied therein. It is also to be appreciated that numerous embodiments incorporating only part of the preferred embodiment are possible which do not alter, with respect to those parts, the inventive concepts and principles embodied therein. In particular, the thrust bearing assembly 20 and/or stack bearing 40 of the illustrated embodiments may be provided on various devices other than a down hole drill 10. Various ceramic materials may be chosen for different applications as well as various steel or steel alloys, including AISI 8620 carbon alloy tool steel. The present embodiment and optional configurations are therefore to be considered in all respects as exemplary and/or illustrative and not restrictive, the scope of the invention being indicated by the appended claims rather than by the foregoing description, and all alternate embodiments and changes to this embodiment which come within the meaning and range of equivalency of said claims are therefore to be embraced therein.

### PARTS LIST

10. Down Hole Drill
12. Shaft
14. Housing
16. Direction of fluid flow
20. Bearing Assembly
22. First Ring
24. First Raceway
26. Second Ring
28. Second Raceway
30. Ball Track
32. High Modulus Rolling Element
34. Low Modulus Rolling Element
40. Stack Bearing
42. Row
DH. Diameter of High Modulus Rolling Element
DL. Diameter of Low Modulus Rolling Element

What is claimed is:

1. A bearing assembly comprising:
a first ring with a first raceway and a second ring with a second raceway and a ball track defined between the raceways;
a plurality of high modulus rolling elements having a first diameter disposed in the ball track; and
a plurality of low modulus rolling elements having a second diameter and disposed in the ball track in an alternating relationship with the high modulus rolling elements, the second diameter being greater than the first diameter,
wherein a ratio of the first diameter to the second diameter is configured to:
distribute an externally applied load to both the high modulus rolling elements and the low modulus rolling elements,
initially distribute more of the externally applied load to the low modulus rolling elements, and
after usage of the bearing assembly and wear of the low modulus rolling elements, distribute the load more evenly between the high modulus rolling elements and the low modulus rolling elements.

2. The bearing assembly of claim 1, wherein the low modulus rolling elements have a diameter that is about 8 to about 20 microns greater than a diameter of the high modulus rolling elements.

3. The bearing assembly of claim 1, wherein, initially, the ratio is configured to distribute from about 60% to about 80% of an externally applied load to the low modulus rolling elements.

4. The bearing assembly of claim 3, wherein, after usage, the ratio is configured to distribute from about 40% to about 50% of the externally applied load to the low modulus rolling elements.

5. The bearing assembly of claim 1, wherein the plurality of low modulus rolling elements have a diameter of about 15.855 mm to about 15.880 mm.

6. The bearing assembly of claim 1, wherein the ratio is about 99.80% to 99.50%.

7. The bearing assembly of claim 6, wherein the plurality of low modulus rolling elements have a diameter of about 15.875 mm and the plurality of high modulus rolling elements have a diameter of about 15.855 mm.

8. The bearing assembly of claim 6, wherein, initially, the ratio is configured to transfer about 70% of the externally applied load to the low modulus rolling elements.

9. The bearing assembly of claim 1, wherein the plurality of high modulus rolling elements have a modulus of about 315,000 MPa and the plurality of low modulus rolling elements have a modulus of about 210,000 MPa.

10. The bearing assembly of claim 1, wherein the plurality of high modulus rolling elements are formed of a ceramic material and the plurality of low modulus rolling elements are formed of steel.

11. The bearing assembly of claim 10, wherein the ceramic material is Si₃N₄ and the steel is S2 tool steel.

12. The bearing assembly of claim 1, wherein the rolling elements are balls.
